(19) United States
(12) Patent Application Publication
(10) Pub. No.: US 2002/0166205 A1
(43) Pub. Date: Nov. 14, 2002

(54) Polymer tool handle with steel core

(76) Inventor: Jaime Hernan Sanchez Rodriguez, Bogota, CO (US)

Correspondence Address: BROWN & MICHAELS, PC, 400 M & T BANK BUILDING, 118 NORTH TIOGA ST, ITHACA, NY, 14850, US

(21) Appl. No.: 09/911,981

(22) Filed: Jul. 24, 2001

(30) Foreign Application Priority Data
May 11, 2001 (CO) 01-39415

(51) Int. Cl. E05B 1/00

(52) U.S. Cl. 16/110.1

(57) ABSTRACT

A handle for tools such as shovels or the like which is formed by a core of steel coated with polymer material, making it light and at the same time very resistant. The steel core is straight for two thirds of its length, then tapers in a conical section. The polymer coating is uniform in thickness over the straight section of the core, then increases in thickness over the conical section to a waist, then reduces to the original thickness.

### BACKGROUND OF THE INVENTION

1. Field of the Invention

The invention pertains to the field of handles for tools. More particularly, the invention pertains to handles for tools of the type of shovels and the like.

2. Description of Related Art

State of the Technique: are known the handles traditional for tools as shovels and similar which are facts of wood for which not they are very resistant and besides they turn out to be heavy and of difficult management. The handle of the model of utility of the reference given its form turns out to be light, very resistant by presenting a core of steel and of easy and adequate manipulation due to its coating that besides should do it slip, absorbs the vibrations of the impact during its utilization, that is what causes tiredness and deterioration of the skin.

### SUMMARY OF THE INVENTION

The invention is a handle for tools such as shovels or the like which is formed by a core of steel coated with polymer material, making it light and at the same time very resistant. The steel core is straight for two thirds of its length, then tapers in a conical section. The polymer coating is uniform in thickness over the straight section of the core, then increases in thickness over the conical section to a waist, then reduces to the original thickness.

### BRIEF DESCRIPTION OF THE DRAWING

FIG. 1 shows a longitudinal section of the tool handle of the invention.

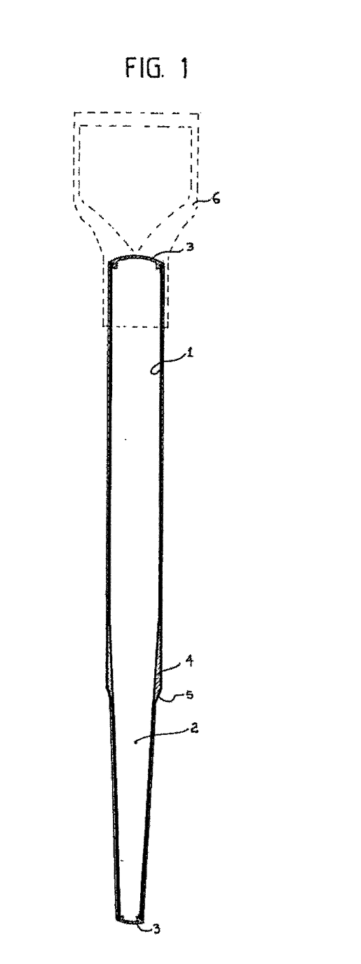

### DETAILED DESCRIPTION OF THE INVENTION

The handle is formed by a tubular steel core 1, which is straight for approximately two thirds of its length downward, then tapers in a conical stock section 2. Each end of the tubular core carries a plug 3. The tubular steel core is coated 4 with a polymer material, preferably a mixture of polyethylene-polypropylene. The thickness of the coating 4 increases slightly over the conical section 2 until a point where a waist 5 is formed, then continues uniformly with the same initial thickness. This final portion 2 of the handle is slightly narrower and of conical form, permitting the handle to be inserted surely and adequately into the corresponding tool.

The combination of the metallic pipe with the coating of polymer material results in a handle which is resistant and at the same time light-desirable mechanical properties in this type of tool.

Complementing the handle of the invention, a grip (6) of polymer material can optionally be mounted on the upper end of the handle. Preferably, in such case the handle and the grip are formed as a single piece, which facilitates still more their adequate and sure manipulation.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A handle for a tool, comprising:
a tubular steel core having an upper end and a lower end and a length therebetween, an upper portion forming approximately two thirds of the length being cylindrical, and a lower portion being conical;
the tubular steel core being coated in a polymer material, having a consistent thickness over the upper portion of the core, the thickness increasing slightly over the conical lower portion to a waist, then continuing to cover the conical lower portion uniformly with the consistent initial thickness.

2. The handle of claim 1, further comprising a plug in the upper end of the tubular steel core.

3. The handle of claim 1, further comprising a plug in the lower end of the tubular steel core.

4. The handle of claim 1, in which the polymer material is a mixture of polyethylene and polypropylene.

5. The handle of claim 1, further comprising a grip on the upper end of the tubular steel core.

6. The handle of claim 5, in which the grip is made of a polymer material.
